(19) United States
(12) Patent Application Publication
(10) Pub. No.: US 2026/0204161 A1
(43) Pub. Date: Jul. 16, 2026

(54) Validating Mapped Charging Stations for Motor Vehicles

(71) Applicant: Bayerische Motoren Werke Aktiengesellschaft, Muenchen (DE)

(72) Inventors: Andreas HACKELOEER, Sankt Augustin (DE); Matthias KRAUS, Muenchen (DE)

(21) Appl. No.: 19/134,280

(22) PCT Filed: Jan. 17, 2024
(86) PCT No.: PCT/EP2024/050962

§ 371 Date: May 30, 2025

(30) Foreign Application Priority Data
Jan. 24, 2023 (DE) 10 2023 101 611.3

(51) Int. Cl. G08G 1/00; B60L 53/60; G01C 21/00

(52) U.S. Cl. CPC G08G 1/205; G01C 21/3811; B60L 53/60

(57) ABSTRACT

The present disclosure relates to a method for validating entries of mapped charging stations, wherein each entry is assigned a geographical position of the charging station, having the steps of detecting locations of charging processes, which have actually been carried out or which are actually being carried out, of at least one motor vehicle; assigning locations lying spatially together to groups; assigning an entry for a mapped charging station to a nearby group; and determining entries which are assigned to precisely one respective group.

### BACKGROUND AND SUMMARY

The present disclosure relates to the validation of cartographic information. In particular, the present disclosure relates to the validation of mapped charging stations for an electric motor vehicle.

An electrically powered motor vehicle comprises an energy storage unit that can be charged at a stationary charging station. A trip with the motor vehicle can be planned in such a way that charging stations are visited frequently enough to ensure that the energy storage unit is not discharged beyond a predetermined level.

To plan a trip, map information can be used in which entries for charging stations are recorded. However, the quality of such entries has proven to be inconsistent. If entries from different information providers are combined in a single map, contradictory or duplicate entries may be included.

For route planning, for example, a driver of the motor vehicle may be shown charging stations that are located within a predetermined search area, such as at a current location, a destination, or along a route to the destination. If the entries are unreliable, it may be difficult for the driver to find or select a suitable entry.

One object underlying the present invention is to provide an improved technique for validating mapped charging stations for a motor vehicle. The invention addresses this object through the subject matter of the independent claims. The dependent claims disclose preferred embodiments.

According to a first aspect of the present invention, a method for validating entries of mapped charging stations, wherein each entry is assigned a geographical position of the charging station, comprises the steps of detecting locations of actual charging processes of at least one motor vehicle; assigning spatially adjacent locations to groups; assigning an entry for a mapped charging station to a nearby group; and determining entries that are each assigned to precisely one group.

The determined entries can be considered validated, whereas locations that are assigned to no group or multiple groups are not considered validated. By determining the validated entries, the non-validated entries are simultaneously identified. A charging station may comprise multiple charging columns, each of which provides a single motor vehicle with an opportunity to charge its energy storage unit. Each charging column can be assigned a parking space for a motor vehicle. As a rule, all charging columns of a charging station are provided by the same operator. An actual charging process in this context includes a charging process that has already occurred or is currently taking place. A merely planned, upcoming, or failed charging process does not qualify as actual in this sense. The charging process includes an increase in the extractable electrical energy from the energy storage unit, preferably by a significant amount, for example by at least 2% or at least 5% of the total capacity. The existence of the charging station at the assigned location can be confirmed by referencing its proven functionality.

The charging station is permanently installed. Changing its geographical position usually requires at least conversion or installation work and may be regarded as decommissioning the charging station at the old location and constructing another charging station at the new location. A mobile charging station, charging the energy storage unit through recuperation or an onboard energy source such as a photovoltaic system or a generator, or any other charging of the energy storage unit not tied to a predetermined location, is not considered a charging station.

Using the method, it is possible, on the one hand, to determine the quality of existing entries and, on the other hand, to identify entries of higher quality. The probability that an entry assigned to exactly one group represents an actually existing and functional charging station at the geographical position assigned to the entry or group can be high. A trip with the motor vehicle can be better planned or executed based on such entries.

In some implementations, locations of charging processes from a large number of motor vehicles are detected. The motor vehicles may be part of a fleet operated, for example, by a vehicle manufacturer, a company, a municipality, or a consortium of private individuals. Information about actual charging processes can be automatically determined and collected by the motor vehicle. Such information may already be collected for quality assurance purposes. The provision of the information may be voluntary, and a driver may decide whether or not to provide data about a charging process. The collected data can form the basis for the method described herein.

In general, the greater the number of motor vehicles for which charging processes are determined, the better the entries can be checked for consistency. Providing information from different individuals or, in this case, from their associated motor vehicles is also known as crowdsourcing.

In some implementations, two entries assigned to the same group are merged. This enables duplicates to be efficiently eliminated. Similarly, more than two entries assigned to the same group may also be merged. Various approaches are conceivable for determining the geographical position of a resulting entry. For example, the position of one of the entries may be used. In a preferred embodiment, the position may be determined as the center of gravity, in particular the geometric mean, of the positions of the included entries. The position may also be determined in another way, such as the Fermat point that minimizes the sum of all distances to the positions of the included entries.

It may be determined what proportion of entries are each assigned to exactly one group. For these entries, a bijective mapping to groups can be specified. Conversely, it may also be determined what proportion of entries are not each assigned to exactly one group. This proportion includes entries that are assigned to more than one group or to no group at all. For the entries in this proportion, there is no bijective mapping to a group. If the former proportion is large and/or the latter proportion is small, then the quality of a previously performed method for suppressing duplicates can be regarded as high. Conversely, the quality of the method may be regarded as low if the former proportion is small and/or the latter proportion is large.

An entry that is assigned to exactly one group can be considered validated. A method for determining a charging station for a motor vehicle can preferentially take into account such validated entries. For example, a list of entries can be generated representing candidates for charging stations to be visited in response to a predetermined search. In the list, validated entries can be displayed in a prominent position, in particular at the beginning of the list. A driver may plan or carry out a trip with an electrically powered motor vehicle more effectively based on the displayed entries in the list.

If multiple groups can be assigned to the same entry, then the charging station described by the entry may comprise correspondingly distributed charging columns. For example, a small building such as a kiosk or a restroom facility may separate a first group of charging columns from a second group. For route planning purposes, groups that can be assigned to the same entry can be merged. Optionally, a note may be added to the entry indicating locally grouped charging columns. The note may include a position for one of the original groups.

To determine spatially adjacent locations, a method known as DBSCAN (Density-Based Spatial Clustering of Applications with Noise) is preferably used. This allows density-based assignment of locations to groups (clusters). Noise points can be ignored and returned separately. A noise point can represent a location that could not be assigned to any group. The DBSCAN method has proven effective for solving clustering problems, and libraries implementing DBSCAN are available for various programming environments.

The DBSCAN method uses a first parameter known as the neighborhood length or ε, and a second parameter known as the minimum number of points or minPts. One or both parameters may also be used by another clustering method applied to determine groups. It is preferred that a neighborhood length of approximately 10 m is used. Extensive tests have shown that this length offers a particularly good compromise between forming too few and too many groups.

It is further preferred that at least two locations are required to form a group. When using the DBSCAN method, the minPts parameter can therefore be set to two. It has been shown that even based on two locations, a useful determination of the geographical position of a charging station can be made. In another embodiment, for example, three or five locations may be required to form a group.

In a further embodiment, a new entry is created based on a group that does not have an assigned entry. In addition to the geographical position of the charging station, an entry may include further information, such as charging power, the applicable energy price, or whether the charging can be carried out using direct current or alternating current. These details for the newly created entry can be determined from the accompanying information of the underlying charging processes. In one embodiment, a newly created entry may also be validated. This allows the same attribute to be conferred upon it as an originally existing entry that could be positively verified on the basis of observed charging processes.

In a further embodiment, a group whose locations are in a residential area may be excluded from the creation of a new entry. This takes advantage of the fact that public charging stations in residential areas are usually well mapped in the entries. An additional charging station in a residential area may be limited in use to a private individual or a resident of a housing complex.

In some implementations, the geographical position of a group is determined as the geometric mean of the included positions. A location that is near the group may have a distance from the group's position that falls below a predetermined threshold. This threshold can correspond to the neighborhood length in the DBSCAN method.

According to a further aspect of the present invention, a device for validating entries of mapped charging stations, wherein each entry is assigned a geographical position of the charging station, comprises a first interface for detecting locations of actual charging processes of at least one motor vehicle; a second interface for detecting the entries of mapped charging stations; and a processing unit. The processing unit is configured to assign spatially adjacent locations to groups; to assign an entry for a mapped charging station to a nearby group; and to determine entries that are each assigned to precisely one group.

The processing unit may be configured to execute, in whole or in part, a method as described herein. To this end, the processing unit may be implemented electronically and, for example, comprise a programmable microcomputer or microcontroller, and the method may be provided as a computer program product with program code means.

The computer program product may also be stored on a computer-readable data carrier. Features or advantages of the method may be transferred to the device, or vice versa.

According to yet another aspect of the present invention, a system comprises a device as described herein and at least one motor vehicle that is configured to provide a location of an actual charging process. Preferably, the system comprises a plurality of such motor vehicles. In one embodiment, a central entity is provided, which is configured to receive and collect locations of actual charging processes of the motor vehicles. The central entity may also be operated independently of the system.

### BRIEF DESCRIPTION OF THE DRAWINGS

Embodiments and implemetnations of the invention are now described in greater detail with reference to the accompanying drawings, in which:

FIG. 1 shows a system;

FIG. 2 shows an illustration of geographical data; and

FIG. 3 illustrates a flowchart of a method.

### DETAILED DESCRIPTION OF THE DRAWINGS

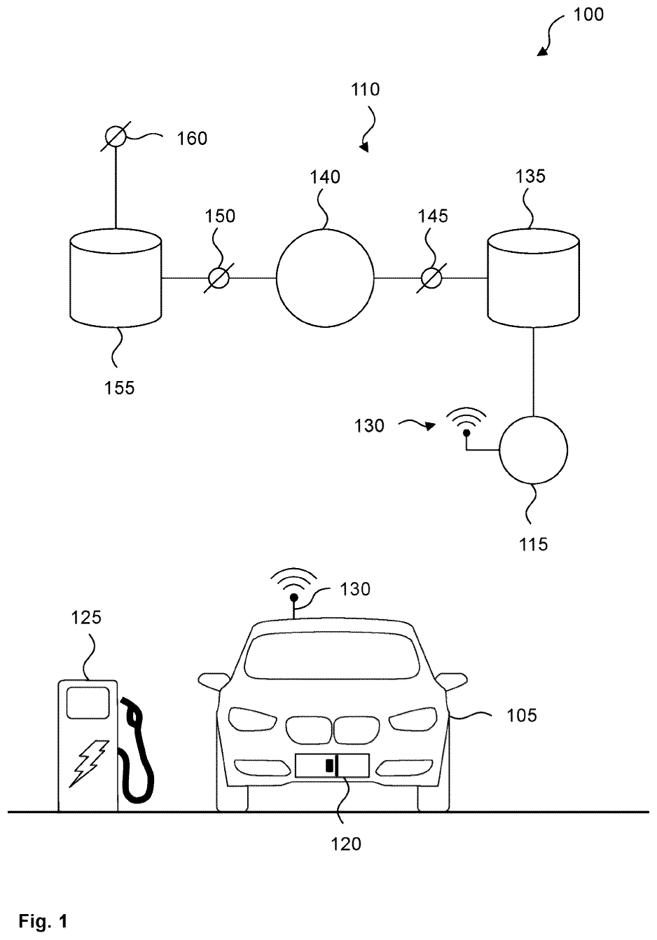

FIG. 1 shows a system 100, which comprises at least one motor vehicle 105 and a device 110. Additionally, a central entity 115 may be included in system 100. The motor vehicle 105 includes an electric energy storage unit 120 that can be charged at a charging station 125. The charging station 125 is stationary and can be assigned a geographical position. For a charging process, the motor vehicle 105 must be directly located at the charging station 125.

The motor vehicle 105 is preferably configured to provide information about a charging process that is currently taking place or has just taken place. For this purpose, the motor vehicle 105 may include a wireless interface 130. The central entity 115 may also be equipped with a wireless interface 130 and thereby receive the information provided by the motor vehicle 105. It is preferred that the central entity 115 collects the received information about actual charging processes of one or more motor vehicles 105 in a data storage unit 135. The information can be maintained in a conventional manner, for example by discarding or excluding information referring to a time that lies further in the past than a predetermined threshold.

The device 110 preferably comprises a processing unit 140, a first interface 145, and a second interface 150. The first interface 145 is configured for connection to the central entity 115 or its data storage unit 135. The second interface 150 is configured to receive entries of mapped charging stations 125. These may be stored in an additional data storage unit 155. The data storage unit 155 may be populated via an interface 160 from one or more different sources. Entries in the additional data storage unit 155 are not necessarily disjoint or uniquely assigned to a charging station 125. To improve uniqueness, to eliminate duplicates, or to remove untrusted entries, a further processing unit may be provided, the operation of which is not relevant here.

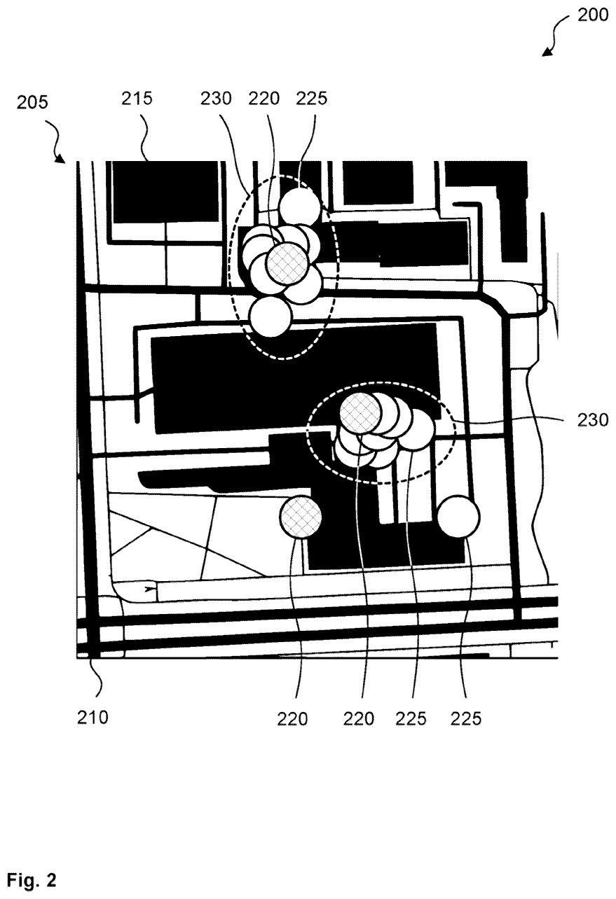

FIG. 2 shows an illustration 200 of geographical data. A geographical map 205 shows, by way of example, roads 210 and buildings 215. Entries 220, each representing a charging station 125, are depicted as hatched circles. Lightly filled circles symbolize locations 225 where a charging process has taken place at a charging station 125.

Each entry 220 and each location 225 is assigned a geographical position that can be displayed on the geographical map 205. All geographical positions may be subject to some uncertainty or determination error. An entry 220 may include a position that is even farther from the actual-unknown-position of a charging station 125 than typically caused by a measurement error. Entries 220 have already been observed that are located in the middle of a body of water or in undeveloped areas. Such entries 220 are not trustworthy and may be eliminated based on any conventional heuristics before being stored in the data storage unit 155. Entries that have exceeded a predetermined age may also be disregarded or entirely removed from the data storage unit 155.

It is proposed that nearby locations 225 be grouped into clusters or groups 230. A group 230 can be assigned a geographical position determined on the basis of its members, i.e., the locations 225. The group 230 can then be assigned to an entry 220 whose position is less than a predetermined distance away from the position of the group 230. The general aim is to establish a one-to-one mapping between groups 230 and entries 220. An entry 220 for which this is possible can be considered validated. An entry 220 that is assigned to none or multiple groups 230, by contrast, cannot be considered validated. Optionally, such an entry 220 may be discarded. A location 225 that cannot be assigned to any group 230 is preferably also discarded. An unassigned entry 220 and an unassigned location 225 are shown in the lower part of the illustration 200.

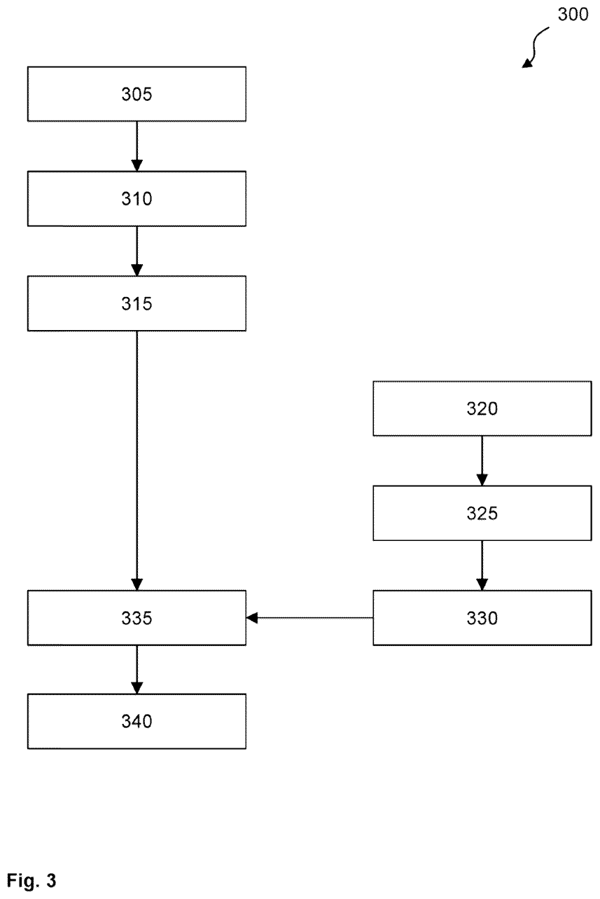

FIG. 3 shows a flowchart of a method 300 for validating entries 220 of mapped charging stations 125. The method 300 is preferably executed by a device 110.

In a step 305, a plurality of entries 220 can be collected, with each entry referring to a charging station 125 and including its geographical position. Entries 220 may originate from different sources and exhibit varying levels of currency or reliability. In a step 310, the entries 220 can be deduplicated in order to merge or combine pairs of entries 220 that represent the same charging station 125. Any known heuristic can be used for this purpose. In a step 315, the cleaned or uncleaned entries 220 may be made available. It should be noted that the steps 305 to 315 are not necessarily part of the method 300 and may also be carried out using a device other than the device 110.

In accordance with the method, in a step 320, charging processes are detected that have actually been or are being carried out using a motor vehicle 105 at a charging station 125. Some motor vehicles 105 transmit an indication of a completed charging process as part of an LSC (Last State Call) message. This message includes a geographical position of the motor vehicle 105, determined by a positioning device, for example based on a satellite navigation system. The messages are preferably collected by a central entity 115 and made available for the purposes of the method 300. The messages preferably originate from a plurality of motor vehicles 105 and pertain to a large number of charging processes at a variety of different charging stations 125.

In a step 325, locations 225 can be grouped into clusters 230. For this, the DBSCAN method is preferably applied, with a neighborhood length of approximately 10 m and a minimum number of points minPts set to two being further preferred.

In a step 330, a geographical position can be determined for a group 230. In a preferred embodiment, this is calculated as the geometric mean of the geographical positions of the locations 225 included in the group 230.

In a step 335, the positions of the entries 220 can be compared with the positions of the groups 230. An entry 220 can be assigned to a group 230 (or vice versa) if the distance between their positions is below a predetermined threshold.

In a step 340, the assignments can be evaluated. In particular, entries 220 can be determined that are each uniquely assigned to exactly one group 230. This means that such an entry 220 is assigned to no more and no fewer than one group 230, and that this group 230 is not assigned to any other entry 220. These entries 220 may be considered validated. A search for a charging station 125 within a predetermined geographical search area may preferentially consider such entries 220 that have been validated in this way.

In addition, the step 340 may include an evaluation of the quality of the entries 220 in the secondary data storage unit 155. Specifically, a proportion of bijectively assigned entries 220 and/or a proportion of non-bijectively assigned entries 220 can be determined. Using such metrics, the quality of the entries 220 or the quality of the deduplication performed in the step 310—especially with regard to sensitivity and specificity—can be assessed. If the evaluation falls short of a predetermined threshold, the approach taken in the step 310 may be revised.

### REFERENCE SIGNS

100 System
105 Motor vehicle
110 Device
115 Central entity
120 Electric energy storage unit
125 Charging station
130 Wireless interface
135 Data storage unit
140 Processing unit
145 First interface
150 Second interface
155 Additional data storage unit
160 Interface
200 Illustration
205 Geographical map
210 Road
215 Building
220 Entry
225 Location
230 Group, cluster
300 Method
305 Capture entries
310 Deduplicate
315 Provide
320 Detect charging processes
325 Form groups
330 Determine positions of groups
335 Assign
340 Evaluate

1-13. (canceled)

14. A method for validating entries of mapped charging stations, wherein each entry is assigned a geographical position of a charging station, the method comprising:
detecting locations of actual charging processes of at least one motor vehicle;
assigning spatially adjacent locations to groups;
assigning an entry for a mapped charging station to a nearby group; and
determining entries that are each assigned to exactly one group.

15. The method according to claim 14, wherein locations of charging processes of a plurality of motor vehicles are detected.

16. The method according to claim 14, wherein two entries that are assigned to the same group are merged.

17. The method according to claim 14, wherein it is determined what proportion of entries are each assigned to exactly one group.

18. The method according to claim 14, wherein:
an entry that is assigned to exactly one group is validated; and
a method for determining a charging station for a motor vehicle considers entries that are validated.

19. The method according to claim 14, wherein spatially adjacent locations are determined using a DBSCAN method.

20. The method according to claim 19, wherein a neighborhood length of approximately 10 m is used.

21. The method according to claim 14, wherein at least two locations are required to form a group.

22. The method according to claim 14, wherein a new entry is created based on a group that is not assigned to any entry.

23. The method according to claim 22, wherein a group is not considered when its locations are situated in a residential area.

24. The method according to claim 14, wherein the geographical position of a group is determined as the geometric mean of the included positions.

25. A device for validating entries of mapped charging stations, wherein each entry is assigned a geographical position of the charging station, the device comprising:
a first interface for detecting locations of actual charging processes of at least one motor vehicle;
a second interface for detecting entries of mapped charging stations; and
a processing unit configured to:
assign spatially adjacent locations to groups;
assign an entry for a mapped charging station to a nearby group; and
determine entries that are each assigned to exactly one group.

26. A system, comprising:
a device according to claim 25; and
at least one motor vehicle configured to provide a location of an actual charging process.
